(19) United States
(12) Patent Application Publication
(10) Pub. No.: US 2021/0127431 A1
(43) Pub. Date: Apr. 29, 2021

(54) ELECTRONIC DEVICE FOR TRANSMITTING DATA TO EXTERNAL ELECTRONIC DEVICE NOT CONNECTED THERETO, AND OPERATION METHOD OF ELECTRONIC DEVICE

(71) Applicant: Samsung Electronics Co., Ltd., Suwon-si (KR)

(72) Inventors: Sanghyeok KIM, Suwon-si (KR); Yeji KANG, Suwon-si (KR); Jinyup KIM, Suwon-si (KR); Yunsik BAE, Suwon-si (KR); Sangchul YUN, Suwon-si (KR); Sunkee LEE, Suwon-si (KR)

(21) Appl. No.: 17/061,480

(22) Filed: Oct. 1, 2020

(30) Foreign Application Priority Data
Oct. 28, 2019 (KR) 10-2019-0134955

(51) Int. Cl. H04W 76/10; H04W 76/34; H04W 4/80

(52) U.S. Cl. CPC H04W 76/10; H04W 4/80; H04W 76/34

(57) ABSTRACT

An electronic device and a method of operation. The electronic device may include: a first communication circuit that supports first communication, a second communication circuit that supports second communication, and a processor configured to: configure a data transmission path using the first communication with a first external electronic device, and based on data received over the data transmission path, determine whether to transmit, to a second external electronic device, data by the first external electronic device. The processor is also configured to control the first or the second communication circuit to establish a data transmission path between the first and the second communication circuits; control the first communication circuit to transmit data received by the first communication circuit from the first external electronic device, to the second communication circuit; and control the second communication circuit to transmit the data to the second external electronic device by using the second communication.

### CROSS-REFERENCE TO RELATED APPLICATION

This application is based on and claims priority under 35 U.S.C. 119 to Korean Patent Application No. 10-2019-0134955 filed on Oct. 28, 2019 in the Korean Intellectual Property Office, the disclosure of which is herein incorporated by reference in its entirety.

### BACKGROUND

### 1. Field

Various embodiments relate to an electronic device for transmitting data to an external electronic device not connected thereto, and an operation method of the electronic device.

### 2. Description of Related Art

Various electronic devices, such as a smart phone, a tablet PC, a portable multimedia player (PMPs), a personal digital assistant (PDAs), a laptop personal computer (PC), and a wearable device, are being distributed.

The electronic device supports various communication means, and may transmit data to or receive data from an external electronic device connected via various communication means. The external electronic device may have a limited number of electronic devices that may be concurrently paired or connected.

The above information is presented as background information only to assist with an understanding of the disclosure. No determination has been made, and no assertion is made, as to whether any of the above might be applicable as prior art with regard to the disclosure.

### SUMMARY

The number of electronic devices to which an external electronic device can be connected is limited, and therefore a situation in which the external electronic device is unable to be connected to an electronic device may occur. In this case, an electronic device may not be able to connect to the external electronic device, and may be able to neither transmit data to the external electronic device nor receive data transmitted by the external electronic device before the external electronic device is disconnected from another electronic device.

There may be a case in which an electronic device needs to be temporarily connected to an external electronic device that is connected to another electronic device. In order for an electronic device and an external electronic device to be connected to each other, an operation of releasing a connection to the external electronic device by another electronic device connected to the external electronic device needs to be preceded, and the operation of releasing the connection between the external electronic device and the another electronic device may cause inconvenience to a user.

An electronic device according to various embodiments may include: a first communication circuit that supports first communication; a second communication circuit that supports second communication; and a processor, wherein the processor is configured to: configure a data transmission path using the first communication with a first external electronic device; based on data received over the data transmission path via the first communication, determine whether to transmit, to a second external electronic device, data to be transmitted by the first external electronic device; in response to determining to perform data transmission to the second external electronic device, control the first communication circuit or the second communication circuit so as to establish a data transmission path between the first communication circuit and the second communication circuit; control the first communication circuit to transmit data received by the first communication circuit from the first external electronic device, to the second communication circuit via the established data transmission path; and control the second communication circuit to transmit the data to the second external electronic device by using the second communication.

An electronic device according to various embodiments may include: a memory; a first communication circuit that supports first communication; a second communication circuit that supports second communication; and a processor, wherein the processor is configured to: configure a data transmission path using the first communication with a first external electronic device; based on data received over the data transmission path via the first communication, determine whether to perform data transmission to a second external electronic device via the first external electronic device; in response to determining to perform data transmission to the second external electronic device via the first external electronic device, control the first communication circuit or the second communication circuit so as to establish a data transmission path between the first communication circuit and the second communication circuit; control the second communication circuit so that the second communication circuit having received data stored in the memory transmits the data to the first communication circuit via the established data transmission path; and control the first communication circuit to transmit the data to the first external electronic device.

An operation method of an electronic device according to various embodiments may include: configuring a data transmission path using first communication with a first external electronic device; based on data received from the first external electronic device over the data transmission path via the first communication, determining whether to perform data transmission to a second external electronic device via the first external electronic device; in response to determining to perform data transmission to the second external electronic device by the first external electronic device, establishing a data transmission path between a first communication circuit supporting the first communication and a second communication circuit supporting second communication; transmitting data received from the first external electronic device by a first communication module, to the second communication circuit via the established data transmission path; and transmitting the data to the second external electronic device via the second communication.

In an electronic device and an operation method of the electronic device according to various embodiments, a second electronic device transmits data to be transmitted to an external electronic device, to a first electronic device via first communication, and the first electronic device may transmit the data to the external electronic device via second communication. The second electronic device is able to transmit data to the external electronic device without releasing a connection between the external electronic device and the first electronic device, so that user usability can be increased.

In the electronic device and the operation method of the electronic device according to various embodiments, a data transmission path is generated between a first communication circuit supporting first communication and a second communication circuit supporting second communication, so that a latency caused by data passing through a processor can be reduced.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an electronic device according to various embodiments;

FIG. 2 illustrates a block diagram of a program according to various embodiments;

FIG. 3 illustrates a diagram of a first electronic device, a second electronic device, and an external electronic device according to various embodiments;

FIG. 4 illustrates a block diagram of a first electronic device according to various embodiments;

FIG. 5 illustrates a block diagram of a second electronic device according to various embodiments;

FIG. 6 illustrates a diagram of operations of a first electronic device, a second electronic device, and an external electronic device according to various embodiments;

FIG. 7A illustrates a diagram of data transmission via first communication between a first electronic device and a second electronic device according to various embodiments, and FIG. 7B illustrates a diagram of data transmission via the first communication between the first electronic device and the second electronic device according to various embodiments;

FIG. 8A illustrates a diagram of a flow in which data transmitted by a second electronic device is received to an external electronic device according to various embodiments, FIG. 8B illustrates a diagram of a flow in which data transmitted by the second electronic device is received to the external electronic device according to various embodiments, FIG. 8C illustrates a diagram of a flow in which data transmitted by the second electronic device is received to the external electronic device according to various embodiments, and FIG. 8D illustrates a diagram of a flow in which data transmitted by the second electronic device is received to the external electronic device according to various embodiments;

FIG. 9A illustrates a diagram of a screen displayed on a display of a first electronic device according to various embodiments, and FIG. 9B illustrates a diagram of a screen displayed on the display of the first electronic device according to various embodiments;

FIG. 10A illustrates a diagram of a screen displayed on a display of a second electronic device according to various embodiments, and FIG. 10B illustrates a diagram of a screen displayed on the display of the second electronic device according to various embodiments;

FIG. 11 illustrates an operation flowchart of an operation method of a first electronic device according to various embodiments; and

FIG. 12 illustrates an operation flowchart of an operation method of a second electronic device according to various embodiments.

### DETAILED DESCRIPTION

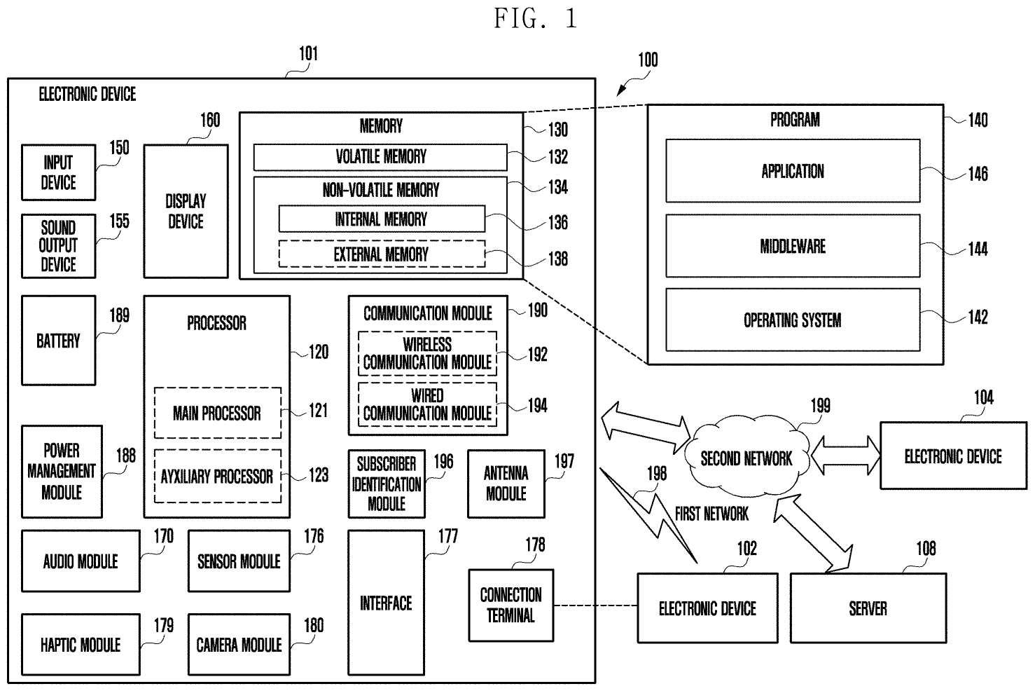

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the sub scriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

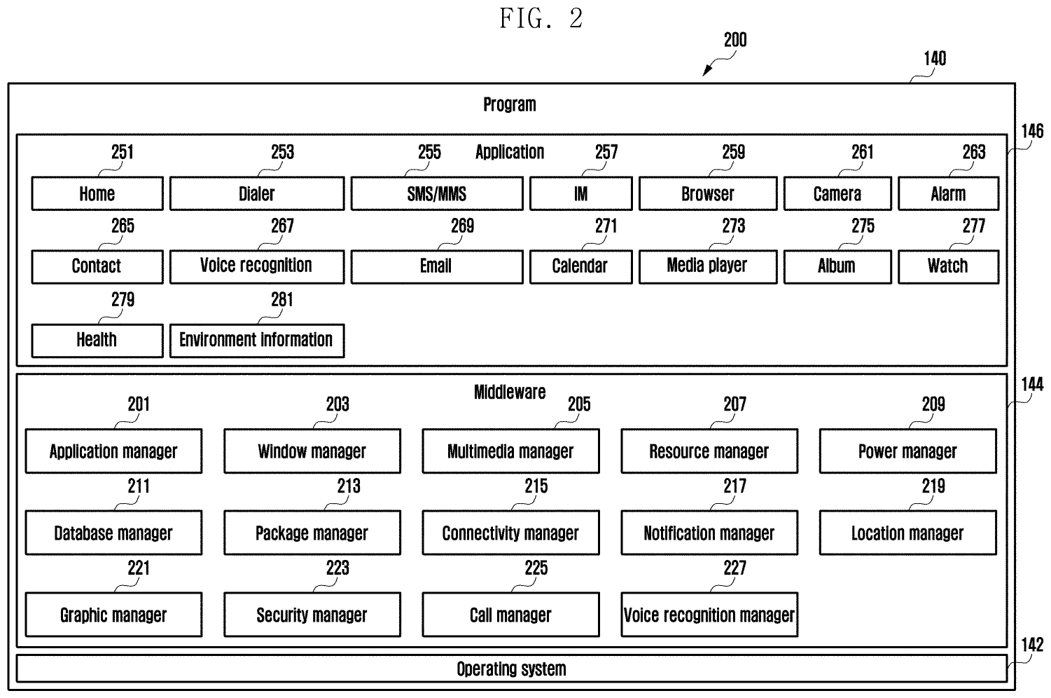

FIG. 2 is a block diagram 200 illustrating the program 140 according to various embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

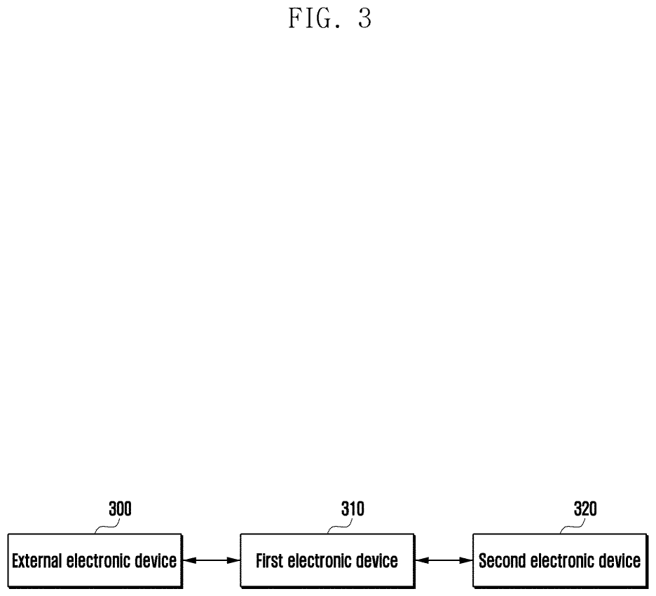

FIG. 3 illustrates a diagram of a first electronic device, a second electronic device, and an external electronic device according to various embodiments.

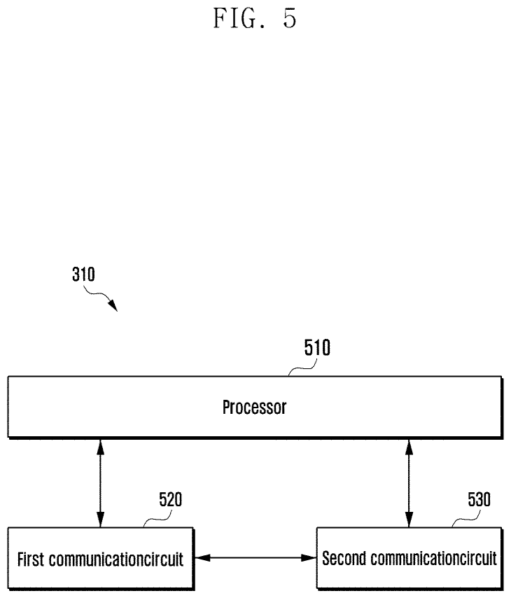

According to various embodiments, a first electronic device 310 (e.g., the electronic device 101 of FIG. 1 or the electronic device 104 of FIG. 1) may be connected to a second electronic device 320 (e.g., the electronic device 104 or electronic device 101 of FIG. 1) via first communication, and may transmit or receive data via the first communication. The first communication may refer to a communication channel connection via a first communication circuit (e.g., a first communication circuit 520 of FIG. 5), and a communication connection via a first communication protocol corresponding to the first communication. The first communication is a communication scheme different from second communication that is a communication scheme via which the first electronic device 310 and an external electronic device 300 are connected, and may refer to short-range wireless communication based on neighbor awareness networking (NAN). For example, the first communication may refer to WI-FI awareness-based communication defined in WI-FI or a communication scheme defined in WI-FI Direct.

According to various embodiments, the external electronic device 300 may be connected to the first electronic device 310 via a second communication so as to transmit data to or receive data from the first electronic device 310. The external electronic device 300 may refer to various electronic devices (e.g., a speaker, a display, a head-up display (HUD) included inside a vehicle, or a vehicle system) which may be connected to the first electronic device 310 via the second communication. The external electronic device 300 may be paired or connected to the first electronic device 310 so as to receive data from the first electronic device 310 and perform various operations based on the received data. For example, the external electronic device 300 may be an output device (e.g., a speaker or a display) that outputs a content, and the external electronic device 300 may receive data from the first electronic device 310 and may output the received data. The second communication is communication different from the first communication that is a communication scheme via which the first electronic device 310 and the second electronic device 320 are connected, and may refer to short-range wireless communication. For example, the second communication may refer to any one of BLUETOOTH communication and BLUETOOTH low energy (BLE) communication.

According to various embodiments, the number of electronic devices that can be concurrently connected to the external electronic device 300 may be limited. If the number of electronic devices connected to the external electronic device 300 is greater than or equal to a specific number, the external electronic device 300 may not be able to be connected to another electronic device (e.g., the second electronic device 320). In the specification, for the convenience of description, it is assumed that the number of electronic devices that can be connected to the external electronic device 300 is one. In this case, before a connection between the external electronic device 300 and the first electronic device 310 via the second communication is released, the second electronic device 320 may not be able to be connected to the external electronic device 300 via the second communication, and furthermore, the second electronic device 320 may not be able to perform data transmission to the external electronic device 300. Hereinafter, described are embodiments in which the external electronic device 300 receives data transmitted by the second electronic device 320 in a state where the connection between the first electronic device 310 and the external electronic device 300 is maintained.

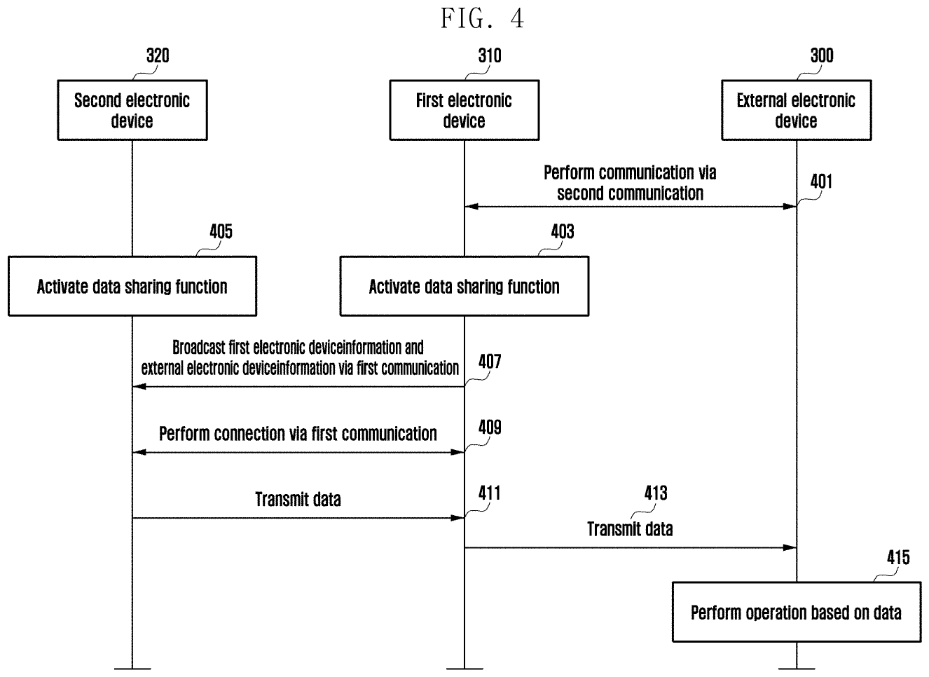

FIG. 4 illustrates a diagram of operations of a first electronic device, a second electronic device, and an external electronic device according to various embodiments.

FIG. 4 describes an embodiment related to an operation of transmitting data to an external electronic device (e.g., the external electronic device 300 of FIG. 3) by a second electronic device (e.g., the second electronic device 320 of FIG. 3) via a first electronic device (e.g., the first electronic device 310 of FIG. 3).

According to various embodiments, in operation 401, the first electronic device 310 and the external electronic device 300 may perform mutual connection using the second communication.

According to various embodiments, the second communication is communication different from the first communication that is a communication scheme via which the first electronic device 310 and the second electronic device 320 are connected, and may refer to short-range wireless communication. For example, the second communication may refer to any one of BLUETOOTH communication or BLUETOOTH low energy (BLE) communication.

According to various embodiments, the first electronic device 310 may transmit, to the external electronic device 300, a signal for requesting of a connection via the second communication. The external electronic device 300 may transmit identification information of the external electronic device 300 and capability information of the external electronic device 300 to the first electronic device 310 in response to reception of the connection request signal.

According to various embodiments, the capability information of the external electronic device 300 may include whether an element (e.g., a display or speaker) included in the external electronic device 300 is present, and information (e.g., information relating to a function of outputting a content in the form of sound by the external electronic device 300 and information related to a function of outputting a content in the form of a screen by the external electronic device 300) on a function that can be performed by the external electronic device 300.

According to various embodiments, in operation 403, the first electronic device 310 may activate a data sharing function.

According to various embodiments, the data sharing function may refer to a function to support an operation of transmitting data to the external electronic device 300 by the second electronic device 320 via the first electronic device 310 and an operation of transmitting data to the second electronic device 320 by the external electronic device 300 via the first electronic device 310.

According to various embodiments, the first electronic device 310 may activate the data sharing function in response to confirming that a specific condition (e.g., various conditions including a condition of receiving a user input for activating the data sharing function, a condition of determining that a predesignated electronic device (e.g., the second electronic device 320) is present within a preconfigured distance from the first electronic device 310, or a condition of receiving, from the second electronic device 320, a signal requesting to activate the data sharing function) is satisfied.

According to various embodiments, the first electronic device 310 may activate a first communication circuit (e.g., a first communication circuit 520 of FIG. 5) that supports the first communication, in response to activation of the data sharing function.

According to various embodiments, in operation 405, the second electronic device 320 may activate a data sharing function.

According to various embodiments, the second electronic device 320 may activate the data sharing function in response to confirming that a specific condition (e.g., various conditions including a condition of receiving a user input for activating the data sharing function, a condition of determining that a predesignated electronic device (e.g., the first electronic device 310) is present within a preconfigured distance from the second electronic device 320, or a condition of receiving, by the second electronic device 320, a signal requesting to activate the data sharing function) is satisfied.

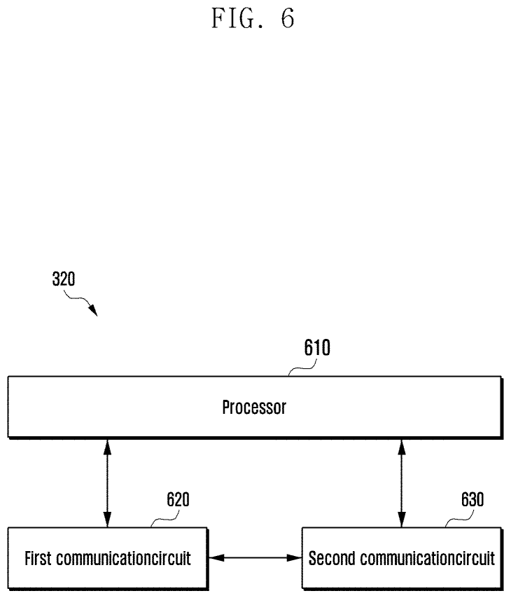

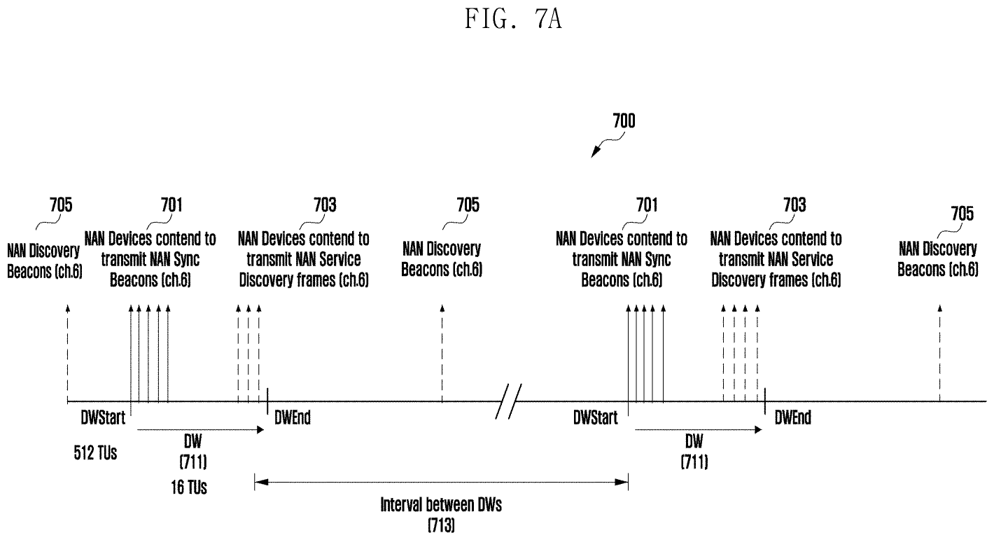

According to various embodiments, the second electronic device 320 may activate the first communication circuit (e.g., a first communication circuit 620 of FIG. 6) that supports the first communication, in response to activation of the data sharing function.

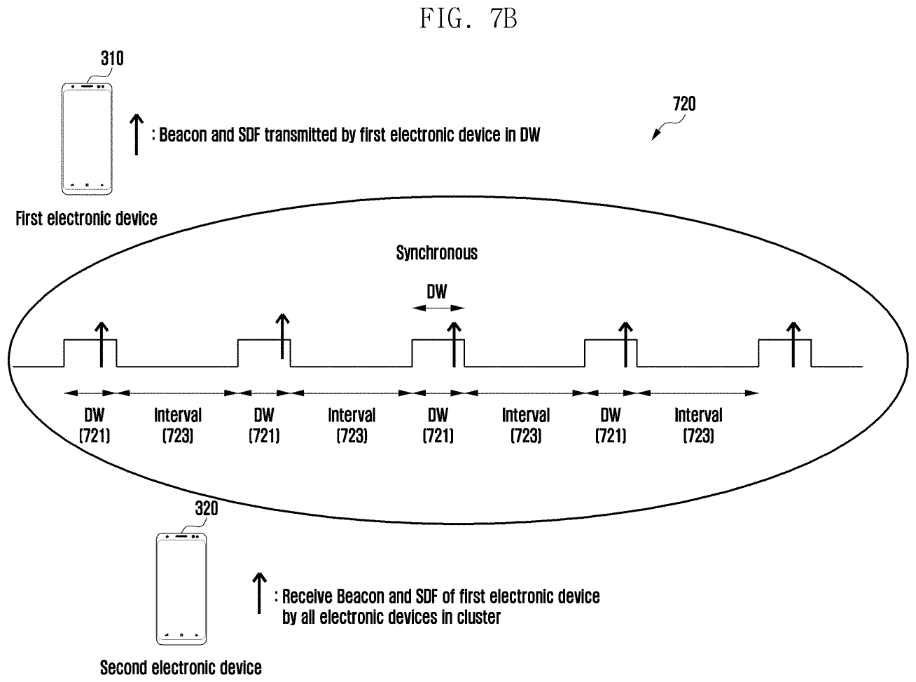

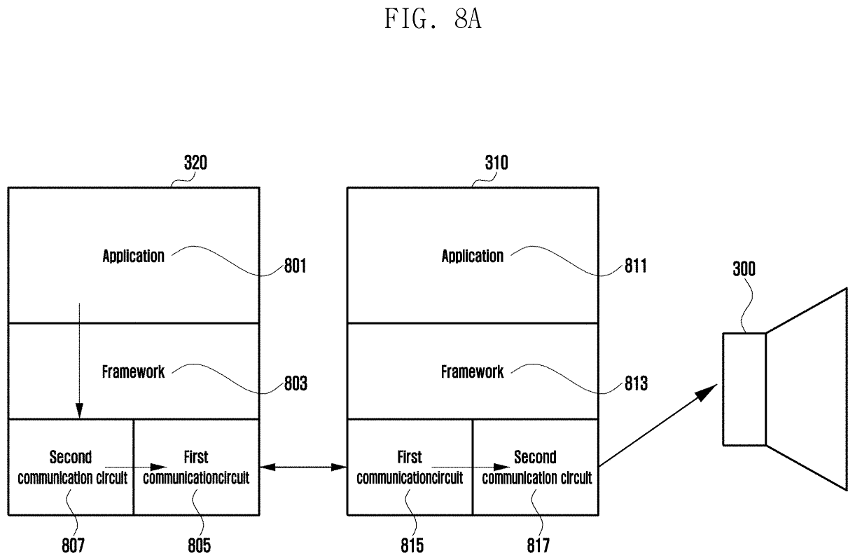

According to various embodiments, in operation 407, the first electronic device 310 may broadcast information of the first electronic device 310 and the external electronic device 300 via the first communication. The first communication is communication different from second communication that is a communication scheme via which the first electronic device 310 and the external electronic device 300 are connected, and may refer to short-range wireless communication based on neighbor awareness networking (NAN). For example, the first communication may refer to WI-FI awareness-based communication defined in WI-FI or communication defined in WI-FI Direct. Data transmission using the first communication will be described later in FIG. 7A and FIG. 7B.

According to various embodiments, information of the first electronic device 310 may include information (e.g., information of an installed application that supports the data sharing function, or information on a function supported by the installed application) indicating whether the first electronic device 310 supports the data sharing function, identification information of the first electronic device 310, and capability information (e.g., content encoding information) of the first electronic device 310. Information of the external electronic device 300 may include identification information of the external electronic device 300 and/or capability information of the external electronic device 300.

According to various embodiments, the second electronic device 320 may receive information of the first electronic device 310 and information of the external electronic device 300, which are broadcasted via the first communication, by activating the first communication circuit. The second electronic device 320 may receive information of the first electronic device 310 and information of the external electronic device 300, which are broadcasted via the first communication, and may activate the data sharing function on the basis of the received information.

According to various embodiments, in operation 409, the first electronic device 310 and the second electronic device 320 may establish a connection via the first communication.

According to various embodiments, based on information of the first electronic device 310 and information of the external electronic device 300, which are broadcasted via the first communication, the second electronic device 320 may determine whether to establish a connection to the first electronic device 310 via the first communication.

According to various embodiments, in operation 411, the second electronic device 320 may transmit data to be transmitted to the external electronic device 300, to the first electronic device 310 via the first communication.

According to various embodiments, in operation 413, the first electronic device 310 may transmit data, which has been received from the second electronic device 320 via the first communication, to the external electronic device 300 via the second communication.

According to various embodiments, in operation 415, the external electronic device 300 may receive data from the first electronic device 310 via the second communication, and may perform various operations based on the received data.

For example, the external electronic device 300 may be an output device (e.g., a speaker or a display) that outputs a content, and the external electronic device 300 may receive data from the first electronic device 310 and may output the received data.

According to various embodiments, due to the limitation of the number of electronic devices that can be concurrently connected to the external electronic device 300, even if the connection between the second electronic device 320 and the external electronic device 300 is impossible, the second electronic device 320 may obtain information of the external electronic device 300 from the first electronic device 310 via the first communication, and may be able to transmit data to the external electronic device 300 via the first electronic device 310.

FIG. 5 illustrates a block diagram of a first electronic device according to various embodiments.

Referring to FIG. 5, a first electronic device (e.g., the first electronic device 310 of FIG. 3) according to various embodiments may include a processor 510 (e.g., the processor 120 of FIG. 1), a first communication circuit 520, and a second communication circuit 530.

According to various embodiments, the first communication circuit 520 is an element supporting first communication, and may be an element implemented in hardware or software. The first communication is communication different from second communication that is a communication scheme via which the first electronic device 310 and an external electronic device (e.g., the external electronic device 300 of FIG. 3) are connected, and may refer to short-range wireless communication based on neighbor awareness networking (NAN). For example, the first communication may refer to WI-FI awareness-based communication defined in WI-FI or communication defined in WI-FI Direct.

According to various embodiments, the second communication circuit 530 is an element supporting second communication, and may be an element implemented in hardware or software. The second communication is communication different from the first communication that is a communication scheme via which the first electronic device 310 and a second electronic device (e.g., the second electronic device 320 of FIG. 3) are connected, and may refer to short-range wireless communication. For example, the second communication may refer to any one of BLUETOOTH communication and BLUETOOTH low energy (BLE) communication.

According to various embodiments, the first communication circuit 520 and the second communication circuit 530 may be elements included in one packaged communication module. According to another embodiment, the first communication circuit 520 and the second communication circuit 530 may be elements included in different packaged chips.

According to various embodiments, the processor 510 may be operatively connected to the first communication circuit 520 and the second communication circuit 530 so as to control the first communication circuit 520 and the second communication circuit 530.

According to various embodiments, the processor 510 may control the second communication circuit 530 so as to transmit data to or receive data from the external electronic device 300 via the second communication. The processor 510 may transmit data, which is obtained by adding a header including information related to the second communication to data stored in a memory (e.g., the memory 130 of FIG. 1), to the second communication circuit 530, and may control the second communication circuit 530 to transmit the data to the external electronic device 300. The processor 510 may receive information of the external electronic device 300 while establishing a connection to the external electronic device 300 via the second communication. Information of the external electronic device 300 may include identification information of the electronic device 300 and capability information of the external electronic device 300.

According to various embodiments, the capability information of the external electronic device 300 may include whether an element (e.g., a display or speaker) included in the external electronic device 300 is present, and/or information (e.g., information relating to a function of outputting a content in the form of sound by the external electronic device 300 and information related to a function of outputting a content in the form of a screen by the external electronic device 300) on a function that can be performed by the external electronic device 300.

According to various embodiments, the processor 510 may determine whether to activate the data sharing function with the second electronic device 320, in a state where the external electronic device 300 is connected via the second communication. The data sharing function may refer to a function to support an operation of transmitting data to the external electronic device 300 by the second electronic device 320 via the first electronic device 310 and an operation of transmitting data to the second electronic device 320 by the external electronic device 300 via the first electronic device 310.

According to various embodiments, the processor 510 may activate the data sharing function in response to confirming that a specific condition is satisfied. The specific condition may refer to various conditions including a condition of receiving a user input for activating the data sharing function, a condition of determining that a predesignated electronic device (e.g., the second electronic device 320) is present within a preconfigured distance from the first electronic device 310, or a condition of receiving, from the second electronic device 320, a signal requesting to activate the data sharing function. The processor 510 may activate the first communication circuit 520 supporting the first communication, in response to activation of the data sharing function.

According to various embodiments, the processor 510 may broadcast information of the first electronic device 310 and information of the external electronic device 300 via the first communication or the second communication. Information of the first electronic device 310 may include at least a part of information (e.g., information of an installed application supporting the data sharing function and information on a function supported by the installed application) indicating whether the first electronic device 310 supports the data sharing function, a list of at least one external electronic device connected to the first electronic device 310, a function provided by the at least one external electronic device connected to the first electronic device 310, identification information of the first electronic device 310 and/or capability information (e.g., content encoding information) of the first electronic device 310. Information of the external electronic device 300 may include at least a part of identification information of the external electronic device 300 or capability information of the external electronic device 300. A specific embodiment of a broadcasting scheme via the first communication will be described later in FIG. 7A and FIG. 7B.

According to various embodiments, the processor 510 may control the first communication circuit 520 to connect to the second electronic device 320 via the first communication, in response to receiving, by the second electronic device 320, a signal for requesting of a connection via the first communication. As a part of an operation of connecting to the second electronic device 320 via the first communication, the processor 510 may control the first communication circuit 520 to configure a data transmission path based on the first communication with the second electronic device 320.

According to various embodiments, the processor 510 may control the first communication circuit 520 to receive data from the second electronic device 320 via the configured data transmission path.

According to various embodiments, the processor 510 may control the first communication circuit 520 to transmit information (e.g., metadata for contents) associated with data to be transmitted to the external electronic device 300 from among data (e.g., contents) stored in the memory 130, to the second electronic device 320 via the first communication. Based on the above scheme, the second electronic device 320 may also check information associated with data transmitted to the external electronic device 300 by the first electronic device 310.

According to various embodiments, the first communication circuit 520 may configure a data transmission path with the first communication circuit (e.g., a first communication circuit 620 of FIG. 6) of the second electronic device 320 without an operation of an element (e.g., WI-FI Manager, DHCP, or TCP/IP) that manages IP address allocation. In this case, data transmission or reception via the first communication may be implemented regardless of an IP protocol (Internet protocol) address.

In the above-described embodiment, it is described that data, which is transmitted, by the second electronic device 320, to the first electronic device 310 so as to be transferred to the external electronic device 300, is transmitted via the first communication. However, the data may be transmitted via third communication differing from the first communication. For example, after determination that the first electronic device 310 and the second electronic device 320 connect to each other via the first communication (e.g., WI-FI Aware), a communication may be made via third communication (e.g., WI-FI Direct), and then data may be transmitted or received via the third communication.

According to various embodiments, the first communication circuit 520 may transmit received data to the second communication circuit 530. According to an embodiment, the processor 510 may control the first communication module (520) so as to cause the first communication circuit 520 to transmit the received data to the second communication circuit 530 without going through the processor 510, so that a latency associated with transmission of the received data is reduced. To this end, the processor 510 may control the first communication circuit 520 and the second communication circuit 530 to establish a data transmission path between the first communication circuit 520 and the second communication circuit 530.

According to various embodiments, the data transmission path between the first communication circuit 520 and the second communication circuit 530 may be implemented using a queue (not shown) or a memory (not shown) accessible by both the first communication circuit 520 and the second communication circuit 530. The processor 510 may control the first communication module 520 to store data received via the first communication in an accessible memory or queue, and may control the second communication circuit 530 to load the data stored in the memory or queue.

According to various embodiments, the data transmission path between the first communication circuit 520 and the second communication circuit 530 may be implemented in the form of inter-process communication (IPC). The processor 510 may control the first communication circuit 520 to transmit the data received via the first communication to the second communication circuit 530 via IPC.

Based on the above-described scheme, the processor 510 may cause the first communication circuit 520 to transmit the received data to the second communication circuit 530 without going through the processor 510, so that a latency related to transmission of the received data may be reduced.

According to another embodiment, the processor 510 may control the first communication circuit 520 to store the data received thereby in the memory implemented on the processor 510, and may also control the second communication circuit 530 to load the data stored in the memory.

According to various embodiments, the processor 510 may control the second communication circuit 530 to transmit data to the external electronic device 300 via the second communication. The second communication circuit 530 may receive data transmitted by the first communication circuit 520, and may partially edit the received data so as to transmit the data via the second communication. According to an embodiment, the second communication circuit 530 may transmit data, which is generated by removing a header including a part associated with the first communication from the data transmitted by the first communication circuit 520 and then adding a header including a part associated with the second communication, to the external electronic device 300 via the second communication.

FIG. 6 illustrates a block diagram of a second electronic device according to various embodiments.

Referring to FIG. 6, a second electronic device (e.g., the second electronic device 320 of FIG. 3) according to various embodiments may include a processor 610 (e.g., the processor 120 of FIG. 1), a first communication circuit 620, and a second communication circuit 630.

According to various embodiments, the first communication circuit 620 is an element supporting first communication, and may be an element implemented in hardware or software. The first communication is communication different from second communication that is a communication scheme via which a first electronic device (e.g., the first electronic device 310 of FIG. 3) and an external electronic device (e.g., the external electronic device 300 of FIG. 3) are connected, and may refer to short-range wireless communication based on neighbor awareness networking (NAN). For example, the first communication may refer to WI-FI awareness-based communication defined in WI-FI or communication defined in WI-FI Direct.

According to various embodiments, the second communication circuit 630 is an element supporting second communication, and may be an element implemented in hardware or software. The second communication is communication different from the first communication that is a communication scheme via which the first electronic device 310 and the second electronic device 320 are connected, and may refer to short-range wireless communication. For example, the second communication may refer to any one of BLUETOOTH communication and BLUETOOTH low energy (BLE) communication.

According to various embodiments, the first communication circuit 620 and the second communication circuit 630 may be elements included in one packaged communication module. According to another embodiment, the first communication circuit 620 and the second communication circuit 630 may be elements included in different packaged chips.

According to various embodiments, the processor 610 may be operatively connected to the first communication circuit 620 and the second communication circuit 630 so as to control the first communication circuit 620 and the second communication circuit 630.

According to various embodiments, the processor 610 may determine whether to activate the data sharing function with the first electronic device 310. The data sharing function may refer to a function to support an operation of transmitting data to the external electronic device 300 by the second electronic device 320 via the first electronic device 310 and an operation of transmitting data to the second electronic device 320 by the external electronic device 300 via the first electronic device 310.

According to various embodiments, the processor 510 may activate the data sharing function in response to confirming that a specific condition is satisfied. The specific condition may refer to various conditions including a condition of receiving a user input for activating the data sharing function, a condition of determining that a predesignated electronic device (e.g., the first electronic device 310) is present within a preconfigured distance from the second electronic device 320, or a condition of receiving, by the second electronic device 320, a signal requesting to activate the data sharing function. The processor 610 may activate the first communication circuit 620 supporting the first communication, in response to activation of the data sharing function.

According to various embodiments, the processor 610 may receive a signal including information of the first electronic device 310 and information of the external electronic device 300 via the first communication while the first communication circuit 620 is being activated. The signal including information of the first electronic device 310 and information of the external electronic device 300 may be a signal broadcast by the first electronic device 310, and a specific embodiment of a broadcasting scheme via the first communication will be described later in FIG. 7A and FIG. 7B.

According to various embodiments, the processor 610 may determine whether the data sharing function via the first electronic device 310 can be performed based on information of the first electronic device 310 and information of the external electronic device 300. According to an embodiment, in response to determining that the data sharing function via the first electronic device 310 can be performed, the processor 610 may display, on a display (e.g., the display device 160 of FIG. 1), a screen for receiving an indicator indicating that the data sharing function via the first electronic device 310 can be performed and a user input that determines whether to connect to the first electronic device 310 for the data sharing function. The processor 610 may configure a data transmission path via the first communication with the first electronic device 310 in response to reception of a user input indicating to connect to the first electronic device 310.

According to various embodiments, the processor 610 may control the first communication circuit 620 to connect to the first electronic device 310 via the first communication. As a part of an operation of connecting to the first electronic device 310 via the first communication, the processor 610 may control the first communication circuit 620 to configure a data transmission path based on the first communication with the first electronic device 310.

According to various embodiments, the first communication circuit 620 may configure a data transmission path with the first communication circuit (e.g., a first communication circuit 520 of FIG. 5) of the first electronic device 310 without an operation of an element (e.g., WI-FI Manager, DHCP, or TCP/IP) that manages IP address allocation. In this case, data transmission or reception via the first communication may be implemented regardless of an IP protocol (Internet protocol) address.

According to various embodiments, the processor 610 may generate data to be transmitted to the external electronic device 300 on the basis of information of the external electronic device 300. The processor 610 may generate data by using a profile (e.g., an advanced audio distribution profile (A2DP)/hands-free profile (HFP) in a case where the external electronic device 300 is an audio output device, and a human interface device (HID) in a case where the external electronic device 300 is an input device) corresponding to information supportable by the external electronic device 300, which is included in capability information of the external electronic device 300.

According to various embodiments, the processor 610 may first transmit, to the second communication circuit 630, data to be transmitted to the first electronic device 310 via the first communication, and then may control the second communication circuit 630 to transmit the data to the first communication circuit 620. Via the above-described operation, various applications installed in the second electronic device 320 may be implemented to be recognized as being connected between the second electronic device 320 and the external electronic device 300 via the second communication, and the data sharing function may be supported in a manner that does not require separate code modification of the applications.

According to various embodiments, the processor 610 may transmit data received by the second communication circuit 630 to the first communication circuit 620 so as to transmit the data via the first communication. According to an embodiment, the processor 610 may cause the second communication circuit 630 to transmit the data received from the processor 610 to the first communication circuit 620 without going through the processor 610, so that a latency related to transmission of the received data may be reduced. To this end, the processor 610 may control the first communication circuit 620 and the second communication circuit 630 to establish a data transmission path between the first communication circuit 620 and the second communication circuit 630.

According to various embodiments, the data transmission path between the first communication circuit 620 and the second communication circuit 630 may be implemented using a memory (not shown) or a queue (not shown) to which both the first communication circuit 620 and the second communication circuit 630 are accessible. The processor 610 may control the first communication module 620 to store the data received from the processor 610 in an accessible memory or queue, and may control the second communication circuit 630 to load the data stored in the memory or queue.

According to various embodiments, the data transmission path between the first communication circuit 620 and the second communication circuit 630 may be implemented in the form of inter-process communication (IPC). The processor 610 may control the first communication circuit 620 to transmit the data received via the first communication to the second communication circuit 630 via IPC.

Based on the above-described scheme, the processor 510 may cause the first communication circuit 620 to transmit the received data to the second communication circuit 630 without going through the processor 610, so that a latency related to transmission of the received data may be reduced.

According to another embodiment, the processor 610 may control the first communication circuit 620 to store the data received thereby in the memory implemented on the processor 610, and may also control the second communication circuit 630 to load the data stored in the memory.

According to various embodiments, the processor 610 may control the first communication circuit 620 to transmit data to the first electronic device 310 via the first communication. The first communication circuit 620 may receive data transmitted by the second communication circuit 630.

According to various embodiments, the data transmitted to the first communication circuit 620 by the second communication circuit 630 may include a header including information related to the second communication and a payload including data to be transmitted and metadata related to the data. The first communication circuit 620 may partially edit the received data for transmission via the second communication. According to an embodiment, the first communication circuit 620 may transmit data, which is generated by removing a header including a part associated with the second communication from the data transmitted by the second communication circuit 630 and then adding a header including a part associated with the first communication, to the first electronic device 310 via the first communication.

FIG. 7A illustrates a diagram of data transmission via first communication between a first electronic device and a second electronic device according to various embodiments, and FIG. 7B illustrates a diagram of data transmission via the first communication between the first electronic device and the second electronic device according to various embodiments.

FIG. 7A illustrates a diagram 700 of an example of a signal transmission protocol in a proximity network according to various embodiments.

For example, FIG. 7A may show an example diagram for a discovery window according to various embodiments. FIG. 7A describes an example that electronic devices (e.g., the first electronic device 310 and the second electronic device 320 of FIG. 3A) included in one cluster transmit a signal via a specific channel (e.g., channel 6 (ch6)) on the basis of the NAN standard.

Referring to FIG. 7A, electronic devices included in one cluster may transmit a synchronization beacon 701 and a service discovery frames (SDF) 703 in a synchronized discovery window (DW) 711. A discovery beacon 705 may be transmitted by at least one electronic device in an interval 713 (e.g., an interval between discovery windows) other than the discovery window 711. According to an embodiment, the electronic devices may transmit the synchronization beacon 701 and the SDF 703 on the basis of contention. For example, the synchronization beacon 701 and the SDF 703 may be transmitted based on the contention between the respective electronic devices belonging to the cluster. According to an embodiment, the respective electronic devices belonging to the cluster may have a transmission priority of the beacon 701 higher than that of the SDF 703.

According to an embodiment, the discovery window 711 may be an interval in which, for data exchange between the respective electronic devices, the electronic devices are activated from a sleep state, which is a power saving mode, to a wake-up state. For example, the discovery window 711 may be divided into time units (TUs) in millisecond units. According to an embodiment, the discovery window 711 for transmission/reception of the synchronization beacon 701 and the SDF 703 may occupy 16 time units (16 TUs) and may have a cycle (or interval) repeated with 512 time units (512 TUs).

According to an embodiment, the discovery beacon 705 may indicate a signal that is transmitted, so as to enable another electronic device, which has failed to join the cluster, to discover the cluster. For example, the discovery beacon 705 is a signal for notification of the presence of the cluster, and electronic devices that do not participate in the cluster may perform a passive scan and receive the discovery beacon 705 so as to discover and join the cluster.

According to an embodiment, the discovery beacon 705 may include information necessary for synchronization to the cluster. For example, the discovery beacon 705 may include at least one of a frame control (FC) field indicating a signal function (e.g., beacon), a broadcast address, a media access control (MAC) address of a transmission electronic device, a cluster identifier (ID), a sequence control field, a time stamp for a beacon frame, a beacon interval indicating a transmission interval of the discovery beacon 705, or capability information for the transmission electronic device. According to an embodiment, the discovery beacon 705 may include at least one proximity network (or cluster)-related information element. In one embodiment, the proximity network-related information may be referred to as attribute information.

According to an embodiment, the synchronization beacon 701 may represent a signal for maintaining synchronization between synchronized electronic devices in the cluster. The synchronization beacon 701 may be transmitted by a synchronization device among the electronic devices in the cluster. For example, the synchronization device may include an anchor master electronic device, a master electronic device, or a non-master sync device defined in the NAN standard.

According to an embodiment, the synchronization beacon 701 may include information necessary for the electronic devices to synchronize within a cluster. For example, the synchronization beacon 701 may include at least one of a FC field indicating a signal function (e.g., beacon), a broadcast address, a MAC address of a transmission electronic device, a cluster identifier, a sequence control field, a time stamp for a beacon frame, a beacon interval indicating the interval between starting points of the discovery window 711, or capability information for the transmission electronic device. According to an embodiment, the synchronization beacon 701 may include at least one proximity network (or cluster)-related information element. For example, the proximity network-related information may include a content for a service provided via the proximity network.

According to an embodiment, the SDF 703 may represent a signal for data exchange via the proximity network. According to an embodiment, the SDF 703 may represent a vendor-specific public action frame, and may include various fields. For example, the SDF 703 may include a category or action field, and may include at least one piece of proximity network-related information.

As described above, the synchronization beacon 701, the SDF 703, and the discovery beacon 705 may include proximity network-related information. In an embodiment, the proximity network-related information may include an identifier indicating a type of information, a length of the information, and a body field that is corresponding information. According to an embodiment, the corresponding information may include at least one of master indication information, cluster information, service identifier list information, service descriptor information, connection capability information, wireless LAN infrastructure information, peer-to-peer (P2P) operation information, independent basic service set (IBSS) information, mesh information, additional proximity network service discovery information, further availability map information, country code information, ranging information, cluster discovery information, or vendor-specific information.

FIG. 7B illustrates a diagram 720 of an example of data transmission/reception within a cluster according to various embodiments.

For example, FIG. 4 shows an example in which the first electronic device 310 and the second electronic device 320 form one cluster via a short-range wireless communication technology, and each of the electronic devices 310 and 320 may transmit or receive beacons and/or SDFs between each other. According to an embodiment, FIG. 7B describes an example that the first electronic device 310 of the electronic devices 310 and 320 constituting the cluster serves as a master electronic device.

Referring to FIG. 7B, the first electronic device 310 may broadcast a beacon and an SDF within a discovery window 721. According to an embodiment, the first electronic device 310 may broadcast a beacon and an SDF in the discovery window 721 that is repeated in each preconfigured interval (e.g., interval 723).

According to an embodiment, the second electronic device 320 may receive the beacon and the SDF which are broadcasted by the first electronic device 310. According to an embodiment, the second electronic device 320 may receive the beacon and the SDF broadcasted from the first electronic device 310 in each discovery window 721.

According to an embodiment, the beacon transmitted in the discovery window 721 may represent a synchronization beacon, and may include information for maintaining synchronization between the electronic devices 310 and 320. For example, if the electronic devices 310 and 320 are included in the cluster, a time clock may be synchronized to a master electronic device (e.g., the first electronic device 310), and the discovery window 721 may be thus activated at the same time.

According to an embodiment, in an interval (e.g., the interval 723) other than the discovery window 721, the electronic devices 310 and 320 may maintain a sleep state to reduce current consumption. For example, the electronic devices 310 and 320 may operate in a wake state only in the discovery window 721 interval on the basis of the synchronized time clock so as to reduce current consumption.

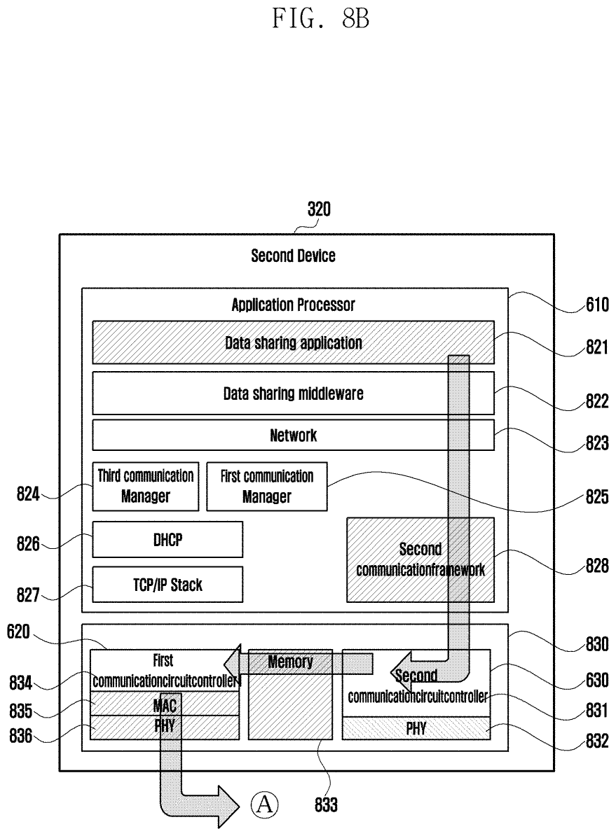

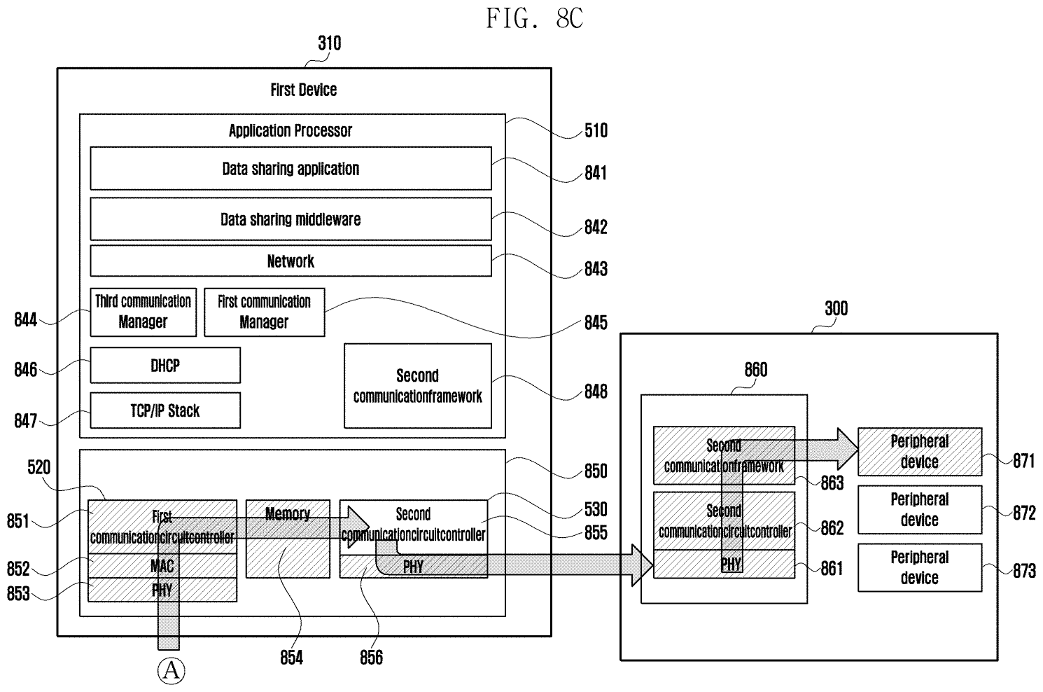

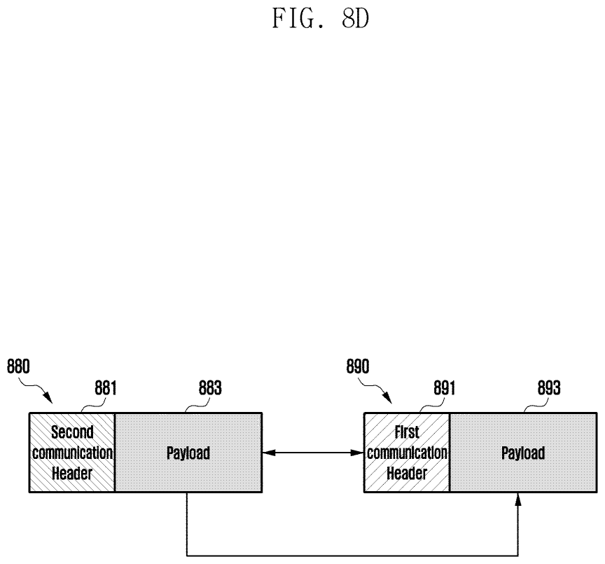

FIG. 8A illustrates a diagram of a flow in which data transmitted by a second electronic device is received to an external electronic device according to various embodiments, FIG. 8B illustrates a diagram of a flow in which data transmitted by the second electronic device is received to the external electronic device according to various embodiments, FIG. 8C illustrates a diagram of a flow in which data transmitted by the second electronic device is received to the external electronic device according to various embodiments, and FIG. 8D illustrates a diagram of a flow in which data transmitted by the second electronic device is received to the external electronic device according to various embodiments.

FIG. 8A illustrates a diagram of an embodiment in which data transmitted by a second electronic device is transmitted to an external electronic device via a first electronic device according to various embodiments.

According to various embodiments, a first electronic device (e.g., the first electronic device 310 of FIG. 5) may be implemented via a software hierarchical structure illustrated in FIG. 8A. The first electronic device 310 may include an application layer 811 including various applications installed on a memory (e.g., the memory 130 of FIG. 1), a framework layer 813 that provides applications with functions provided by one or more elements of the first electronic device 310, a first communication circuit 815 (e.g., the first communication circuit 520 of FIG. 5), and a second communication circuit 817 (e.g., the second communication circuit 530 of FIG. 5) may be included.

According to various embodiments, a second electronic device (e.g., the second electronic device 320 of FIG. 6) may be implemented via the software hierarchical structure illustrated in FIG. 8A. The second electronic device 320 may include an application layer 801 including various applications installed on a memory (e.g., the memory 130 of FIG. 1), a framework layer 803 that provides applications with functions provided by one or more elements of the second electronic device 320, a first communication circuit 805 (e.g., the first communication circuit 620 of FIG. 6), and a second communication circuit 807 (e.g., the second communication circuit 630 of FIG. 6) may be included.

According to various embodiments, for the second electronic device 320, an application supporting a data sharing function from among various applications existing in the application layer 801 of the second electronic device 320 may transmit data to be transmitted to the external electronic device 300, to the second communication circuit 807 by using the data sharing function existing in the framework layer 803. Via the above-described operation, various applications installed in the second electronic device 320 may be implemented to be recognized as being connected between the second electronic device 320 and the external electronic device 300 via the second communication, and the data sharing function may be supported in a manner that does not require separate code modification of the applications.

According to various embodiments, the second communication circuit 807 may transmit the data received from the application layer 801 to the first communication circuit 805. According to an embodiment, a data transmission path may be generated between the second communication circuit 807 and the first communication circuit 805. If no data transmission path exists between the first communication circuit 805 and the second communication circuit 807, the second communication circuit 807 may be required to transmit the received data to the first communication circuit 805 via the framework layer 803 and the application layer 801 so that various applications installed in the second electronic device 320 can be recognized as being connected between the second electronic device 320 and the external electronic device 300 via the second communication. According to various embodiments, a data transmission path is generated between the first communication circuit 805 and the second communication circuit 807, and the second communication circuit 807 transmits the data to the first communication circuit 805 via the data transmission path, so that various applications installed in the second electronic device 320 may be recognized as being connected between the second electronic device 320 and the external electronic device 300 via the second communication, and furthermore, a latency may be reduced.

According to various embodiments, the first communication circuit 805 of the second electronic device 320 may transmit the data to a first communication circuit 815 of the first electronic device 310 via the first communication.

According to various embodiments, the first communication circuit 815 of the first electronic device 310 may transmit the data received from the second electronic device 320 to a second communication circuit 817. According to an embodiment, a data transmission path may be generated between the second communication circuit 817 and the first communication circuit 815. If no data transmission path exists between the first communication circuit 815 and the second communication circuit 817, the first communication circuit 815 may be required to transmit the received data to the second communication circuit 817 via a framework layer 813 and an application layer 811. According to various embodiments, a data transmission path is generated between the first communication circuit 815 and the second communication circuit 817, and the first communication circuit 815 transmits the data to the second communication circuit 817 via the data transmission path, so that a latency may be reduced.

According to various embodiments, the second communication circuit 817 may transmit the data received from the first communication circuit 815 to the external electronic device 300 via the second communication.

Based on the scheme method described above, the second electronic device 320 may transmit data to the external electronic device 300 via the first electronic device 310 even in a state where the second electronic device 320 is not connected to the external electronic device 300.

FIG. 8B illustrates a diagram of an embodiment in which a second electronic device transmits data to be transmitted to an external electronic device, to a first electronic device according to various embodiments.

According to various embodiments, the second electronic device 320 may include a processor (e.g., the processor 610 of FIG. 6) and a communication chipset 830 including a first communication circuit (e.g., the first communication circuit 620 of FIG. 6), a second communication circuit (e.g., the second communication circuit 630 of FIG. 6).

According to various embodiments, the processor 610 may include a data sharing application 821 that performs data sharing, data sharing middleware 822 supporting a data sharing function used by the data sharing application 821, a network 823 supporting various communication-related functions that can be performed by the second electronic device 320, a third communication manager 824 that controls an element (e.g., the first communication circuit 620) that performs a function related to third communication, a first communication manager 825 that controls an element (e.g., the first communication circuit 620) that performs a function related to first communication, a dynamic host configuration protocol (DHCP) manager 826 that manages a configuration of an IP of the second electronic device 320, a transmission control protocol IP (TCP/IP) manager 827 that manages data transmission and reception using an IP, and a second communication framework 828 that controls an element (e.g., the second communication circuit 630) that performs a function related to second communication. The elements described above may be implemented in hardware or software, and some elements may be omitted.

According to various embodiments, the communication chipset 830 is a chipset in which a communication circuit supporting a short-range wireless communication function is implemented, and may include the first communication circuit 620 supporting the first communication, the second communication circuit 630 supporting the second communication, and a memory 833 accessible by both the first communication circuit 620 and the second communication circuit 630.

According to various embodiments, the first communication circuit 620 may include a first communication circuit controller 834 that controls a function related to the first communication, a MAC layer 835 that checks an error of data received from a PHY layer 836 or converts data transmitted from a higher layer into a format for transmission, and the PHY layer 836 that performs various operations (e.g., encoding, modulation, or resource allocation) for transmitting, to the first electronic device 310, data transmitted from the MAC layer 835.

According to various embodiments, the second communication circuit 630 may include a second circuit controller 831 that controls a function related to the second communication, and the PHY layer 832 that performs various operations (e.g., encoding, modulation, or resource allocation) for transmitting, via the second communication, data transmitted by the second communication circuit controller 831.

According to various embodiments, in order to transmit the data to the external electronic device 300 via the second communication, the data sharing application 821 may transmit the data to the second communication framework 828 by using a data sharing function provided by the data sharing middleware 822. The second communication framework 828 may perform processing on the data transmitted by the data sharing application 821 and may transmit the processed data to the second communication circuit controller 831.

According to various embodiments, the second communication circuit controller 831 may transmit the received data to the first communication circuit controller 834 via the memory 833, without transmitting the data to the PHY layer 836. The first communication circuit controller 834 may transmit the data received from the second communication circuit controller 831 to the MAC layer 835 and the PHY layer 836. The data processed by the MAC layer 835 and the PHY layer 836 may be transmitted to the first electronic device 310 via the first communication.

FIG. 8C illustrates a diagram of an embodiment of transmitting, to an external electronic device, data received from a second electronic device by a first electronic device.

According to various embodiments, the first electronic device 310 may include a processor (e.g., the processor 510 of FIG. 5) and a communication chipset 850 including a first communication circuit (e.g., the first communication circuit 520 of FIG. 5), a second communication circuit (e.g., the second communication circuit 530 of FIG. 5).

According to various embodiments, the processor 510 may include a data sharing application 841 that performs data sharing, data sharing middleware 842 supporting a data sharing function used by the data sharing application 841, a network 843 supporting various communication-related functions that can be performed by the first electronic device 310, a third communication manager 844 that controls an element (e.g., the first communication circuit 520) that performs a function related to third communication, a first communication manager 845 that controls an element (e.g., the first communication circuit 620) that performs a function related to first communication, a dynamic host configuration protocol (DHCP) manager 846 that manages a configuration of an IP of the first electronic device 310, a transmission control protocol IP (TCP/IP) manager 847 that manages data transmission and reception using an IP, and a second communication framework 848 that controls an element (e.g., the second communication circuit 530) that performs a function related to second communication. The elements described above may be implemented in hardware or software, and some elements may be omitted.

According to various embodiments, the communication chipset 850 is a chipset in which a communication circuit supporting a short-range wireless communication function is implemented, and may include the first communication circuit 520 supporting the first communication, the second communication circuit 530 supporting the second communication, and a memory 854 accessible by both the first communication circuit 520 and the second communication circuit 530.

According to various embodiments, the first communication circuit 520 may include a first communication circuit controller 851 that controls a function related to the first communication, a MAC layer 835 that checks an error of data received from a PHY layer 853 or converts data transmitted from a higher layer into a format for transmission, and the PHY layer 853 that performs various operations (e.g., decoding or demodulation) for transmitting, to the MAC layer 852, data transmitted from the second electronic device 320.

According to various embodiments, the second communication circuit 530 may include a second circuit controller 855 that controls a function related to the second communication, and the PHY layer 856 that performs various operations (e.g., encoding, modulation, or resource allocation) for transmitting, via the second communication, data transmitted by the second communication circuit controller 855.

According to various embodiments, the external electronic device 300 may include a PHY layer 861 that performs various operations (e.g., decoding or demodulation) for transmitting data received via the second communication to a higher layer, a second communication circuit controller 862 that controls a function related to the second communication, a chipset 860 including a second communication framework 863 that controls an element performing a function related to the second communication, and various elements 871, 872 or 873 (e.g., speaker or display) that output the received data.

According to various embodiments, the first communication circuit controller 851 may receive data transmitted by the second electronic device 320 via the PHY layer 853 and the MAC layer 852. The first communication circuit controller 851 may transmit the data to the second communication circuit controller 855 via the memory 854.

According to various embodiments, the second communication circuit controller 855 may control the PHY layer 856 to transmit the data transmitted by the first communication circuit controller 851, to the external electronic device 300 via the second communication.

According to various embodiments, the external electronic device 300 may receive the data, which is transmitted by the first electronic device 310 via the second communication, via the PHY layer 861, the second communication circuit controller 862, and the second communication framework 863. The external electronic device 300 may check metadata included in the received data, may select elements 871, 872, and 873 to output the data on the basis of a type (e.g., image, sound, or video) of data included in the metadata, and may process and output the data by using the selected element.

The embodiments described in FIG. 8B and FIG. 8C are related to transmitting data to the first electronic device 310 by the second electronic device 320, but the data may be transmitted to the second electronic device 320 by the first electronic device 310. For example, the first electronic device 310 may transmit, via the first communication, information (e.g., metadata of a sound source and a sound source list) on a sound source to be reproduced in the external electronic device 300. As another example, the first electronic device 310 may transmit information on the sound source to the second electronic device 320 via the second communication (e.g., using a GATT profile of BLUETOOTH). The second electronic device 320 may output, on a display, information of the sound source to be output by the external electronic device 300, on the basis of the information on the sound source, which is received via the first communication. Based on the same scheme described above, both the first electronic device 310 and the second electronic device 320 may share the same information on the sound source to be output by the external electronic device 300.

FIG. 8D illustrates a diagram of a data structure transmitted between a first communication circuit and a second communication circuit which are implemented in a first electronic device or a second electronic device according to various embodiments.

A first electronic device (e.g., the first electronic device 310 of FIG. 5) or a second electronic device (e.g., the second electronic device 320 of FIG. 6) according to various embodiments may generate a data path between a first communication circuit (e.g., the first communication module 520 of FIG. 5 or the first communication circuit 620 of FIG. 6) and a second communication circuit (e.g., second communication circuit 530 of FIG. 5 or second communication circuit 630 of FIG. 6).

According to various embodiments, data 880 and 890 transmitted between the first communication circuits 520 and 620 and the second communication circuits 530 and 630 may include headers 881 and 891 and payloads 883 and 893. The headers 881 and 891 may include information related to communication supported by respective communication modules. For example, the header 881 may include information related to the second communication (e.g., identification information of an electronic device related to second communication). As another example, the header 891 may include information (e.g., identification information of an electronic device related to first communication) related to the first communication. The payloads 883 and 893 may include data to be transmitted. The first electronic device 310 or the second electronic device 320 may transmit only the payloads 883 and 893 obtained by removing the headers 881 and 891 from the data 880 and 890, while transmitting the data received via the first communication or the second communication to the higher layer (e.g., an application layer (e.g., the application layers 801 and 811 of FIG. 8A).

According to various embodiments, when the first communication circuits 520 and 620 or the second communication circuits 530 and 630 receive data via the generated data path, the payloads 883 and 893 remaining after removing the headers 881 and 891 from the received data 880 and 890 may be used without a change. For example, the first communication circuit 520 or 620 may receive data 880 from the second communication circuit 530 or 630, and may transmit data generated by removing the header 881 included in the data 880 and adding the header 891 related to the first communication. As another example, the second communication circuit 530 or 630 may receive data 890 from the first communication circuit 520 or 620, and may transmit data generated by removing the header 891 included in the data 890 and adding the header 881 related to the second communication.

The above description may be a scheme using a received payload without a change. By using received payloads without a change, a latency associated with data transmission between the first communication circuits 520 and 620 and the second communication circuits 530 and 630 may be reduced.

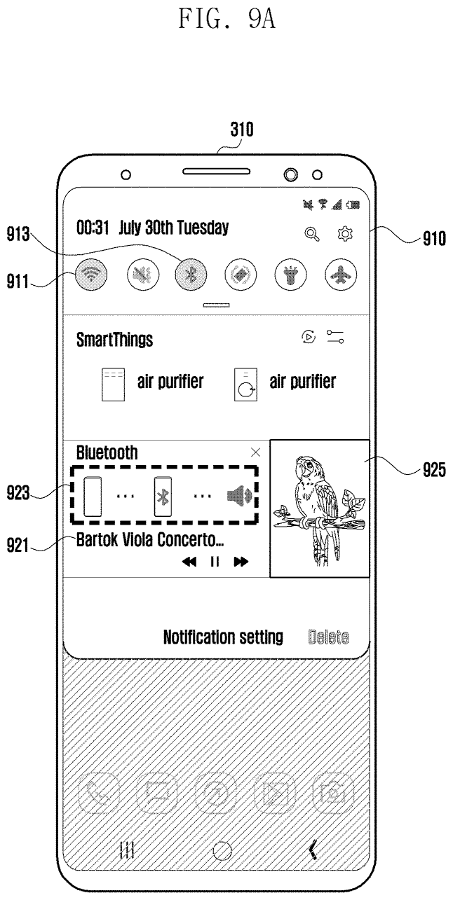

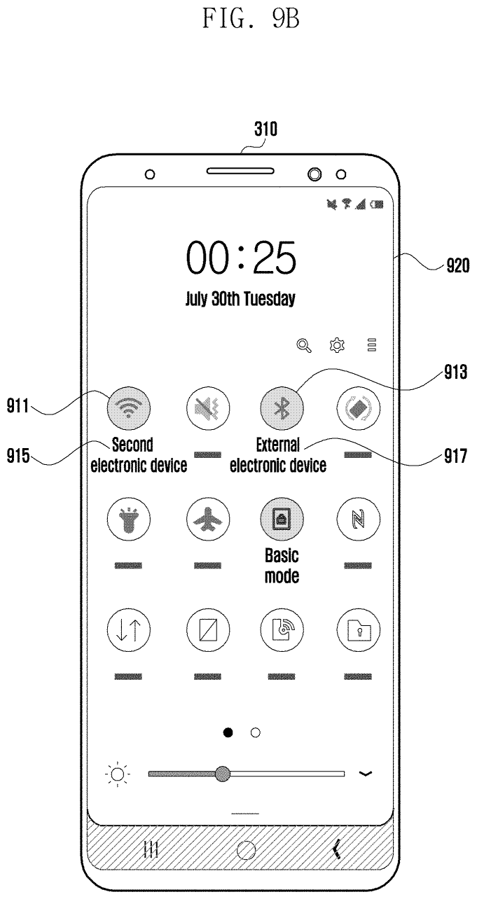

FIG. 9A illustrates a diagram of a screen displayed on a display of a first electronic device according to various embodiments, and FIG. 9B is a diagram illustrating a screen displayed on the display of the first electronic device according to various embodiments.

A first electronic device (e.g., the first electronic device 310 of FIG. 5) according to various embodiment may display information related to a data sharing function on a display 910 (e.g., the display device 160 of FIG. 1). The first electronic device 310 may receive, from a second electronic device (e.g., the second electronic device 320 of FIG. 6), data to be transmitted to an external electronic device (e.g., the external electronic device 300 of FIG. 3), and may transmit a part of the received data to a processor (e.g., the processor 510 of FIG. 5). The first electronic device 310 may display information related to the data sharing function on the basis of the data received by the processor 510. The data received by the processor 510 may be at least a part of data transmitted by the external electronic device 300 via the first communication. For example, the processor 510 may receive metadata (e.g., content information) corresponding to the data (e.g., a content) to be transmitted to the external electronic device 300.

According to another embodiment, the first electronic device 310 may receive, from the external electronic device 300, information (e.g., a content reproduction state) related to data that is output by the external electronic device 300, and may display information related to the data sharing information on the basis of the received information.

Referring to FIG. 9A, the first electronic device 310 may display, on the display 910, information (e.g., a content title 921, an indicator 923 indicating activation of the data sharing function, and content metadata 925) related to the data output on the external electronic device 300.

According to various embodiments, while the data sharing function is being performed, the first electronic device 310 may be connected to the second electronic device 320 via the first communication, and may be connected to the external electronic device 300 via the second communication. Referring to FIG. 9A, the first electronic device 300 may display, on the display 910, an indicator 911 indicating that the first communication is activated and an indicator 913 indicating the second communication is activated.

Referring to FIG. 9B, the indicator 911 related to the first communication may include information 915 indicating that the second electronic device 320 is connected via the first communication. The indicator 913 related to the second communication may include information 917 indicating that the external electronic device 300 is connected via the second communication.

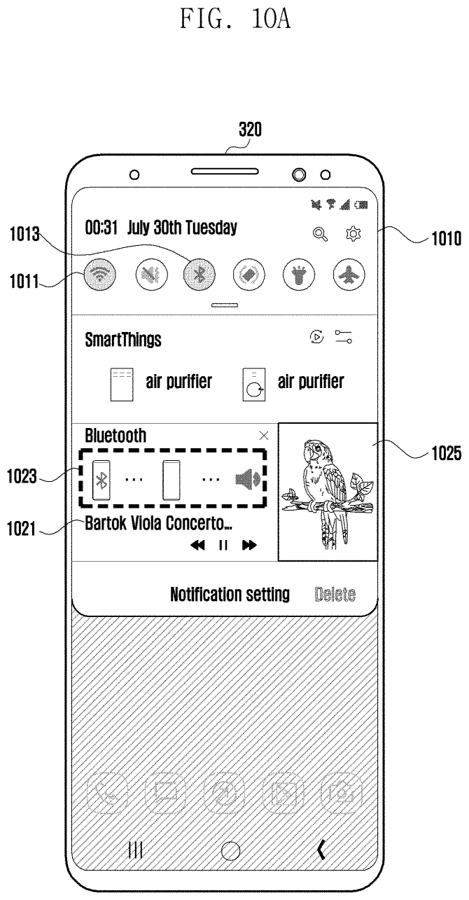

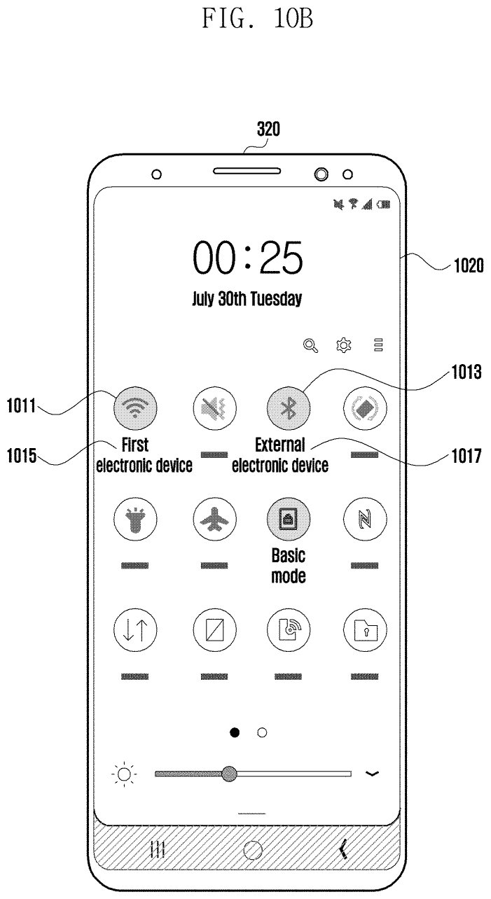

FIG. 10A illustrates a diagram of a screen displayed on a display of a second electronic device according to various embodiments, and FIG. 10B diagram illustrating a screen displayed on the display of the second electronic device according to various embodiments.

A second electronic device (e.g., the second electronic device 320 of FIG. 6) according to various embodiment may display information related to a data sharing function on a display 1010 (e.g., the display device 160 of FIG. 1). The second electronic device 320 may receive information related to a data sharing function from the first electronic device 310 via the first communication. A first communication circuit (e.g., the first communication circuit 620 of FIG. 6) may transmit a part of received data to a processor (e.g., the processor 610 of FIG. 6). The second electronic device 320 may display information related to the data sharing function on the basis of the data received by the processor 610. The data received by the processor 610 may be at least a part of data transmitted by the first electronic device 310 via the first communication. For example, the processor 610 may receive information (e.g., a content reproduction state) related to data output by the external electronic device 300, and may display information related to the data sharing function on the basis of the received information.

Referring to FIG. 10A, the second electronic device 320 may display, on the display 1010, information (e.g., a content title 1021, an indicator 1023 indicating activation of the data sharing function, and content metadata 1025) related to the data output on the external electronic device 300.

According to various embodiments, while the data sharing function is being performed, the second electronic device 320 may be connected to the first electronic device 310 via the first communication, but may not be connected to the external electronic device 300. The second electronic device 320 may be implemented by first transmitting data to a second communication circuit (e.g., the second communication circuit 630 of FIG. 6), so that various applications installed in the second electronic device 320 are recognized as being connected between the second electronic device 320 and the external electronic device 300 via the second communication.

Referring to FIG. 10A, the first electronic device 310 may display, on the display 1010, an indicator 1011 indicating that the first communication is activated and an indicator 1013 indicating the second communication is activated.

Referring to FIG. 10B, the indicator 1011 related to the first communication may include information 1015 indicating that the first electronic device 310 is connected via the first communication. The indicator 1013 related to the second communication may include information 1017 indicating that the external electronic device 300 is connected via the second communication.

The electronic device 310 according to various embodiments may include: the first communication circuit 520 that supports the first communication; the second communication circuit 530 that supports the second communication; and the processor 510, wherein the processor 510 is configured to: configure a data transmission path using the first communication with a first external electronic device 300 [symbol] sed on data received over the data transmission path via the first communication, determine whether to transmit, to a second external electronic device 300, data to be transmitted by the first external electronic device 300; in response to determining to perform data transmission to the second external electronic device 300, control the first communication circuit 520 or the second communication circuit 530 so as to establish a data transmission path between the first communication circuit 520 and the second communication circuit 530; control the first communication circuit 520 to transmit data received by the first communication circuit 520 from the first external electronic device 300, to the second communication circuit 530 via the established data transmission path; and control the second communication circuit 530 to transmit the data to the second external electronic device 300 by using the second communication.

In the electronic device 310 according to various embodiments, the processor 510 may be configured to receive the data from the first external electronic device 300 while maintaining the connection to the second external electronic device 300 via the second communication.

In the electronic device 310 according to various embodiments, the processor 510 may be configured to control the first communication circuit 520 to transmit identification information of the second external electronic device 300, capability information of the second external electronic device 300, and capability information of the electronic device via the first communication.

In the electronic device according to various embodiments, the processor 510 may be configured to: control the second communication circuit 530 to generate data by removing a header related to the first communication from data received by the second communication circuit 530 from the first communication circuit 520 and adding a header related to the second communication; and control the second communication circuit 530 to transmit the generated data to the second external electronic device 300.

In the electronic device according to various embodiments, the processor 510 may be configured to: control the first communication module to store data received from the first external electronic device 300 in a memory accessible by the first communication circuit 520 and the second communication circuit; and control the second communication circuit 530 to load the data stored in the memory.

In the electronic device according to various embodiments, the processor 510 may be configured to control the first communication circuit 520 to receive data to be transmitted to the second external electronic device 300, from the first external electronic device 300 via third communication different from the first communication.

In the electronic device according to various embodiments, the processor 510 may be configured to transmit, to the first external electronic device 300, data related to the data transmitted to the second external electronic device 300.

In the electronic device according to various embodiments, the first communication may be short-range communication based on neighbor awareness networking (NAN), and the second communication may be short-range communication other than the short-range communication based on the NAN.

The electronic device 320 according to various embodiments may include: a memory; the first communication circuit 620 that supports the first communication; the second communication circuit 630 that supports the second communication; and the processor 610, wherein the processor 610 is configured to: configure a data transmission path using the first communication with a first external electronic device 310; based on data received over the data transmission path via the first communication, determine whether to perform data transmission to the second external electronic device 300 via the first external electronic device 310; in response to determining to perform data transmission to the second external electronic device 300 via the first external electronic device 310, control the first communication circuit 620 or the second communication circuit 630 so as to establish a data transmission path between the first communication circuit 620 and the second communication circuit 630; control the second communication circuit 630 so that the second communication module having received data stored in the memory transmits the data to the first communication circuit 620 via the established data transmission path; and control the first communication circuit 620 to transmit the data to the first external electronic device 310.

In the electronic device 320 according to various embodiments, the processor 610 may be configured to: control the first communication circuit 620 to receive, from the second communication circuit 630, data generated to be transmitted via the second communication; control the first communication circuit 620 to generate data by removing a header related to the second communication from data received from the first communication circuit 620 and adding a header related to the first communication; and control the first communication circuit 620 to transmit the generated data to the first external electronic device 310.

In the electronic device 320 according to various embodiments, the processor 610 may be configured to: control the second communication circuit to store the data generated to be transmitted via the second communication in a memory accessible by the first communication circuit 620 and the second communication circuit; and control the first communication circuit 620 to load data stored in the memory by the first communication circuit 620 and the second communication circuit 630.

In the electronic device 320 according to various embodiments, the processor 610 may be configured to transmit the data to the first external electronic device 310 while maintaining the connection via the second communication between the first external electronic device 310 and the second external electronic device 300.

In the electronic device 320 according to various embodiments, the processor 610 may be configured to control the first communication circuit 620 to receive identification information of the second external electronic device 300, capability information of the second external electronic device 300, and capability information of the electronic device via the first communication.

In the electronic device according to various embodiments, the processor 610 may be configured to control the first communication circuit 620 to transmit the data to the first external electronic device via third communication different from the first communication.

In the electronic device 320 according to various embodiments, the processor 610 may be configured to control the first communication circuit 620 so that the first external electronic device 310 receives, via the third communication, data related to the data transmitted to the second external electronic device 300.

In the electronic device 330 according to various embodiments, the first communication may be short-range communication based on neighbor awareness networking (NAN), and the second communication may be short-range communication other than the short-range communication based on the NAN.

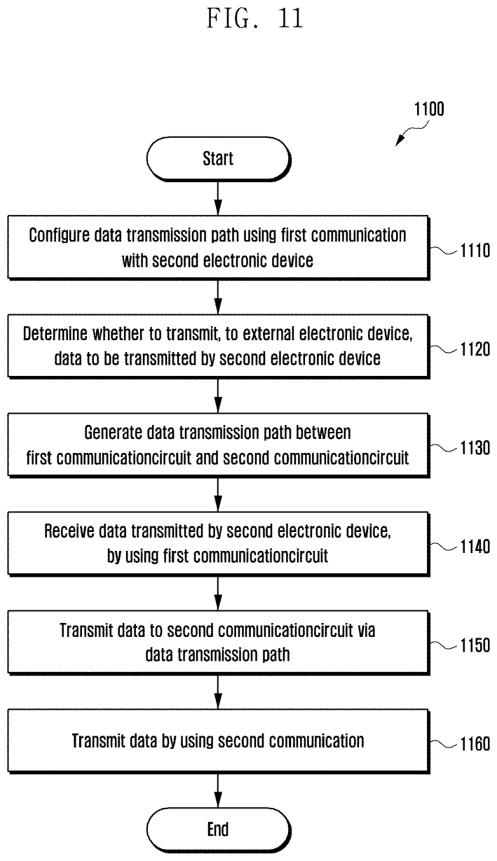

FIG. 11 illustrates an operation flowchart of an operation method 1100 of a first electronic device according to various embodiments.

According to various embodiments, in operation 1110, a first electronic device (e.g., the first electronic device 310 of FIG. 5) may configure a data transmission path using first communication with a second electronic device (e.g., the second electronic device 320 of FIG. 6).

According to various embodiments, the first communication is communication different from second communication that is a communication scheme via which the first electronic device 310 and an external electronic device (e.g., the external electronic device 300 of FIG. 3) are connected, and may refer to short-range wireless communication based on neighbor awareness networking (NAN). For example, the first communication may refer to WI-FI awareness-based communication defined in WI-FI or communication defined in WI-FI Direct.

According to various embodiments, in operation 1120, the first electronic device 310 may determine whether to transmit, to an external electronic device (e.g., the external electronic device 300 of FIG. 3), data to be transmitted by the second electronic device 320.

According to various embodiments, the first electronic device 310 may determine whether to activate a function (a data sharing function) to share data with the second electronic device 320, and may determine to transmit, to the external electronic device 300, data to be transmitted by the second electronic device 320, in response to activation of the data sharing function.

According to various embodiments, in operation 1130, the first electronic device 310 may generate a data transmission path between a first communication circuit (e.g., the first communication circuit 520 of FIG. 5), a second communication circuit (e.g., the second communication circuit 530 of FIG. 5).

According to various embodiments, the data transmission path between the first communication circuit 520 and the second communication circuit 530 may be implemented using a queue (not shown) or a memory (e.g., the memory 854 of FIG. 8C) accessible by both the first communication circuit 520 and the second communication circuit 530. The first electronic device 310 may control the first communication circuit 520 to store data received via the first communication in the accessible memory 854 or queue, and may control the second communication circuit 530 to load the data stored in the memory or queue.

According to various embodiments, the data transmission path between the first communication circuit 520 and the second communication circuit 530 may be implemented in the form of inter-process communication (IPC). The first electronic device 310 may control the first communication circuit 520 to transmit the data received via the first communication to the second communication circuit 530 via IPC.

Based on the above-described scheme, the first electronic device 310 may cause the first communication circuit 520 to transmit the received data to the second communication circuit 530 without going through the processor 510, so that a latency related to transmission of the received data may be reduced.

According to various embodiments, in operation 1140, the first electronic device 310 may receive data transmitted by the second electronic device 320, by using the first communication circuit 520.

According to various embodiments, the first communication circuit 520 may receive data from the second electronic device 320 via the data transmission path configured in operation 1110.

According to various embodiments, the first communication circuit 520 may receive data from the second electronic device 320 via a path other than the data transmission path configured in operation 1110. The first communication circuit 520 may implement a data connection via third communication with the second electronic device 320. For example, after determination that the first electronic device 310 and the second electronic device 320 connect to each other via the first communication (e.g., WI-FI Aware), a communication may be made via third communication (e.g., WI-FI Direct), and then data may be transmitted or received via the third communication.

According to various embodiments, in operation 1150, the first electronic device 310 may transmit the data received by the first communication circuit 520, to the second communication circuit 530 via the generated data transmission path.

According to various embodiments, in operation 1160, the first electronic device 310 may transmit the data to the external electronic device 300 by using the second communication.

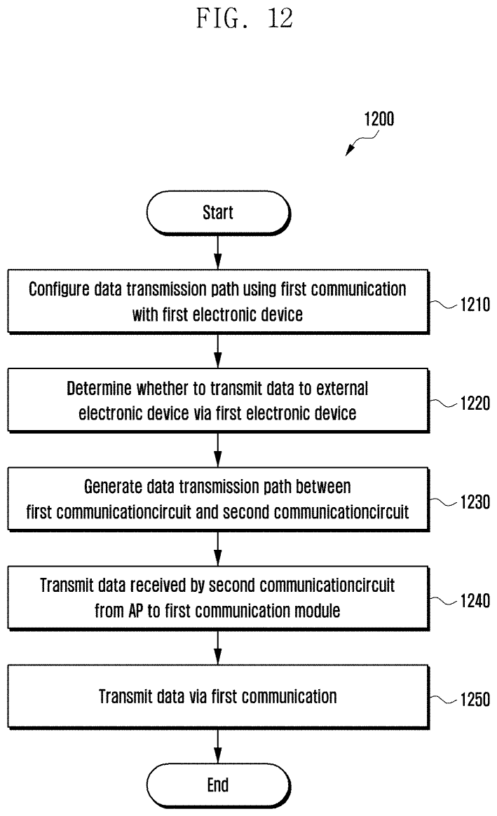

FIG. 12 is an operation flowchart illustrating an operation method 1200 of a second electronic device according to various embodiments.

According to various embodiments, in operation 1210, a second electronic device (e.g., the second electronic device 320 of FIG. 6) may configure a data transmission path using first communication with a first electronic device (e.g., the first electronic device 310 of FIG. 5).

According to various embodiments, the first communication is communication different from second communication that is a communication scheme via which the first electronic device 310 and an external electronic device (e.g., the external electronic device 300 of FIG. 3) are connected, and may refer to short-range wireless communication based on neighbor awareness networking (NAN). For example, the first communication may refer to WI-FI awareness-based communication defined in WI-FI or communication defined in WI-FI Direct.

According to various embodiments, in operation 1220, the second electronic device 320 may determine whether to transmit data to the external electronic device 300 via the first electronic device 310.

According to various embodiments, the second electronic device 320 may activate a data sharing function in response to confirming that a specific condition is satisfied. The specific condition may refer to various conditions including a condition of receiving a user input for activating the data sharing function, a condition of determining that a predesignated electronic device (e.g., the second electronic device 320) is present within a preconfigured distance from the first electronic device 310, or a condition of receiving, by the second electronic device 320, a signal requesting to activate the data sharing function. The second electronic device 320 may activate the first communication circuit 620 supporting the first communication in response to activation of the data sharing function.

According to various embodiments, the second electronic device 320 may receive a signal including information of the first electronic device 310 and information of the external electronic device 300 via the first communication while the first communication circuit 620 is being activated. The signal including information of the first electronic device 310 and information of the external electronic device 300 may be a signal broadcasted by the first electronic device 310.

According to various embodiments, the second electronic device 320 may determine whether the data sharing function via the first electronic device 310 can be performed based on information of the first electronic device 310 and information of the external electronic device 300. According to an embodiment, in response to determining that the data sharing function via the first electronic device 310 can be performed, the second electronic device 320 may display, on a display (e.g., the display device 160 of FIG. 1), a screen for receiving an indicator indicating that the data sharing function via the first electronic device 310 can be performed and a user input that determines whether to connect to the first electronic device 310 for the data sharing function. The second electronic device 320 may configure the data transmission path via the first communication with the first electronic device 310 in response to reception of a user input indicating to connect to the first electronic device 310.

According to various embodiments, in operation 1230, the second electronic device 320 may generate a data transmission path between a first communication circuit (e.g., the first communication circuit 620 of FIG. 6) and a second communication circuit (e.g., the second communication circuit 630 of FIG. 6).

According to various embodiments, the second electronic device 320 may transmit data received by the second communication circuit 630 to the first communication circuit 620 so as to transmit the data via the first communication. According to an embodiment, the second electronic device 320 may cause the second communication circuit 630 to transmit the data received from the processor 610 to the first communication circuit 620 without going through the processor 610, so that a latency related to transmission of the received data may be reduced. To this end, the second electronic device 320 may control the first communication circuit 620 and the second communication circuit 630 to establish a data transmission path between the first communication circuit 620 and the second communication circuit 630.

According to various embodiments, the data transmission path between the first communication circuit 620 and the second communication circuit 630 may be implemented using a queue (not shown) or a memory (e.g., the memory 833 of FIG. 8C) accessible by both the first communication circuit 620 and the second communication circuit 630. The second electronic device 320 may control the first communication circuit 620 to store the data received from a processor (e.g., the processor 610 in FIG. 6) in an accessible memory or queue, and may control the second communication circuit 630 to load the data stored in the memory or queue.

According to various embodiments, the data transmission path between the first communication circuit 620 and the second communication circuit 630 may be implemented in the form of inter-process communication (IPC). The second electronic device 320 may control the first communication circuit 620 to transmit the data received via the first communication to the second communication circuit 630 via IPC.

According to various embodiments, in operation 1240, the second electronic device 320 may transmit data, which is received by the second communication circuit 630 from an application processor (e.g., the processor 610 of FIG. 8B), to the first communication circuit 620 via the data transmission path generated in operation 1230.

According to various embodiments, in operation 1250, the second electronic device 320 may transmit the data to the first electronic device 310 via the first communication.

The operation method of the electronic device according to various embodiments may further include an operation of receiving the data from the first external electronic device 330 while maintaining the connection to the second external electronic device 300 via the second communication.

In the operation method of the electronic device according to various embodiments, the operation of transmitting the data by using the second communication may further include: generating data by removing a header related to the first communication from data received by the second communication circuit 530 from the first communication circuit 520 and adding a header related to the second communication; and transmitting the generated data to the second external electronic device 300.

In the operation method of the electronic device according to various embodiments, the first communication may be short-range communication based on neighbor awareness networking (NAN), and the second communication may be short-range communication other than the short-range communication based on the NAN.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a first communication circuit configured to support first communication;
a second communication circuit configured to support second communication; and
a processor, wherein the processor is configured to:
configure a data transmission path using the first communication with a first external electronic device;
based on data received over the data transmission path via the first communication, determine whether to transmit, to a second external electronic device, data to be transmitted by the first external electronic device;
in response to determining to perform data transmission to the second external electronic device, control the first communication circuit or the second communication circuit so as to establish a data transmission path between the first communication circuit and the second communication circuit;
control the first communication circuit to transmit data received by the first communication circuit from the first external electronic device, to the second communication circuit via the established data transmission path; and
control the second communication circuit to transmit the data to the second external electronic device by using the second communication.

2. The electronic device of claim 1, wherein the processor is configured to receive the data from the first external electronic device in a state where a connection to the second external electronic device via the second communication is maintained.

3. The electronic device of claim 1, wherein the processor is configured to control the first communication circuit to transmit, via the first communication, identification information of the second external electronic device, capability information of the second external electronic device, and capability information of the electronic device.

4. The electronic device of claim 1, wherein the processor is configured to:
control the second communication circuit to generate data by removing a header related to the first communication from the data received by the second communication circuit from the first communication circuit and adding a header related to the second communication; and
control the second communication circuit to transmit the generated data to the second external electronic device.

5. The electronic device of claim 4, wherein the processor is configured to:
control the first communication circuit to store the data received from the first external electronic device in a memory accessible by the first communication circuit and the second communication circuit; and
control the second communication circuit to load the data stored in the memory.

6. The electronic device of claim 1, wherein the processor is configured to control the first communication circuit to receive the data to be transmitted to the second external electronic device, from the first external electronic device via third communication differing from the first communication.

7. The electronic device of claim 1, wherein the processor is configured to transmit, to the first external electronic device, data related to the data transmitted to the second external electronic device.

8. The electronic device of claim 1, wherein the first communication is short-range communication based on neighbor awareness networking (NAN), and the second communication is short-range communication other than the short-range communication based on the NAN.

9. An electronic device comprising:
a memory;
a first communication circuit configured to support first communication;
a second communication circuit configured to support second communication; and
a processor, wherein the processor is configured to:
configure a data transmission path using the first communication with a first external electronic device;
based on data received over the data transmission path via the first communication, determine whether to perform data transmission to a second external electronic device via the first external electronic device;
in response to determining to perform data transmission to the second external electronic device via the first external electronic device, control the first communication circuit or the second communication circuit so as to establish a data transmission path between the first communication circuit and the second communication circuit;
control the second communication circuit so that the second communication circuit including received data stored in the memory transmits the data to the first communication circuit via the established data transmission path; and
control the first communication circuit to transmit the data to the first external electronic device.

10. The electronic device of claim 9, wherein the processor is configured to:
control the first communication circuit to receive, from the second communication circuit, data generated to be transmitted via the second communication;
control the first communication circuit to generate data by removing a header related to the second communication from data received from the first communication circuit and adding a header related to the first communication; and
control the first communication circuit to transmit the generated data to the first external electronic device.

11. The electronic device of claim 10, wherein the processor is configured to:
control the second communication circuit to store the data, which is generated to be transmitted via the second communication, in the memory accessible by the first communication circuit and the second communication circuit; and
control the first communication circuit to load the data stored in the memory by the first communication circuit and the second communication circuit.

12. The electronic device of claim 9, wherein the processor is configured to transmit the data to the first external electronic device in a state where a connection via the second communication between the first external electronic device and the second external electronic device is maintained.

13. The electronic device of claim 9, wherein the processor is configured to control the first communication circuit to receive, via the first communication, identification information of the second external electronic device, capability information of the second external electronic device, and capability information of the electronic device.

14. The electronic device of claim 9, wherein the processor is configured to control the first communication circuit to transmit the data to the first external electronic device via third communication differing from the first communication.

15. The electronic device of claim 14, wherein the processor is configured to control the first communication circuit so as to enable the first external electronic device to receive, via the third communication, data related to the data transmitted to the second external electronic device.

16. The electronic device of claim 9, wherein the first communication is short-range communication based on neighbor awareness networking (NAN), and the second communication is short-range communication other than the short-range communication based on the NAN.

17. An operation method of an electronic device, the operation method comprising:
configuring a data transmission path using first communication with a first external electronic device;
based on data received from the first external electronic device over the data transmission path via the first communication, determining whether to perform data transmission to a second external electronic device via the first external electronic device;
in response to determining to perform data transmission to the second external electronic device by the first external electronic device, establishing a data transmission path between a first communication circuit configured to support the first communication and a second communication circuit configured to support second communication;
transmitting data received from the first external electronic device by the first communication circuit to the second communication circuit via the established data transmission path; and
transmitting the data to the second external electronic device via the second communication.

18. The operation method of claim 17, further comprising: receiving the data from the first external electronic device in a state where a connection to the second external electronic device via the second communication is maintained.

19. The operation method of claim 17, wherein the transmitting of the data by using the second communication comprises:
generating data by removing a header related to the first communication from the data received by the second communication circuit from the first communication circuit and adding a header related to the second communication; and
transmitting the generated data to the second external electronic device.

20. The operation method of claim 17, wherein the first communication is short-range communication based on neighbor awareness networking (NAN), and the second communication is short-range communication other than the short-range communication based on the NAN.
